(19) United States
(12) Patent Application Publication
(10) Pub. No.: US 2026/0352580 A1
(43) Pub. Date: Nov. 5, 2026

(54) ACCESS DEVICE TELEMETRY DATA REPORTING

(71) Applicant: HEWLETT PACKARD ENTERPRISE DEVELOPMENT LP, Spring, TX (US)

(72) Inventor: Venkatavaradhan Devarajan, Bangalore (IN)

(21) Appl. No.: 19/261,398

(22) Filed: Jul. 7, 2025

(30) Foreign Application Priority Data
Apr. 30, 2025 (IN) 202541041666

(51) Int. Cl. H04L 43/0829; H04L 43/06

(52) U.S. Cl. CPC H04L 43/0829; H04L 43/06

(57) ABSTRACT

Systems and methods described herein relate to telemetry reporting by an access device for other networking devices. An access device may generate its own error message or may receive error messages from the other networking devices. Based on the error message(s), the access device may generate telemetry data, which may consolidate telemetry data generation and reporting operations at the access device.

### BACKGROUND

A network includes multiple networking devices connected together. A source device may communicate with a destination device by sending packets through the network. Sometimes a networking device drops a packet while in route through the network. The networking device may report an error message in response to dropping the packet.

### BRIEF DESCRIPTION OF DRAWINGS

Features, aspects, and advantages of the present disclosure will become better understood when the following detailed description is read with reference to the accompanying drawings in which like characters represent like parts throughout the drawings, wherein:

FIG. 1 is a diagram of a system that uses access device telemetry data reporting, in accordance with aspects of the present disclosure;

FIG. 2 is a flow diagram of a process that may be deployed by access device processing resource(s) to implement access device telemetry data reporting, in accordance with aspects of the present disclosure;

FIG. 3 is a diagram of a system that uses access device telemetry data reporting and experiences packet forwarding drops in a network without an overlay network, in accordance with aspects of the present disclosure;

FIG. 4 is a diagram of a system that uses access device telemetry data reporting and experiences a packet forwarding drop in an overlay network, in accordance with aspects of the present disclosure;

FIG. 5 is a flow diagram of a process that may be deployed by access device processing resource(s) to implement access device telemetry reporting after a network access drop occurs, in accordance with aspects of the present disclosure; and

FIG. 6 is a sequence diagram of a process that may be deployed by processing resources of a source device, an access device, a networking device, and a network management system to implement access device telemetry reporting after a network access drop occurs, in accordance with aspects of the present disclosure.

### DETAILED DESCRIPTION

Network devices sometimes drop packets in transferring of packets. One method to track and/or analyze such packets includes dropped packet analysis in a network by using an access switch as a single point for reporting Mirror on Forwarding Drop (MOD) telemetry data to a network management system. MOD telemetry data indicates to the network management system reasons why a packet was dropped by a networking device (e.g., explanation data), what traffic the dropped packet was transmitted with (e.g., traffic identifier), a timestamp of the occurrence (e.g., a timestamp), and a networking device responsible for dropping the packet (e.g., a networking device address). A networking device that drops a packet of traffic may be enabled to report MOD telemetry data, and MOD telemetry data may be reported on a per-network-device basis. Implementing MOD telemetry data reporting on this per-network-device basis may lead to slow or hesitant adoption and/or consume relatively high amounts of resources (e.g., bandwidth) when deploying and maintaining respective networking device configurations. One reason that adoption may be hesitant is that deploying MOD telemetry reporting on all network devices may demand updates to core network components (e.g., spine routers and core configurations). Generally, network administrators may be hesitant to make any changes to such components as such updates may cause failures that may stop the entire network from functioning with potential impacts of such downtimes being costly.

To efficiently use network resources while enabling MOD telemetry data reporting, reporting systems and methods may use access switches (rather than core components) to generate and report MOD telemetry data based on error messages received via a bus (e.g., Internet Control Message Protocol (ICMP) error messages) even when received from other devices and destined for other devices. This enables such MOD telemetry reporting without demanding updates to network core components.

To elaborate, when a packet is dropped by a networking device, the networking device may generate and send, via a bus, an error message. The error message may include type data, code data, checksum data, pointer data, and an original IP datagram as a payload. There is overlap in the information reported in the error message and the information reported in the MOD telemetry data. Thus, an access switch may generate the MOD telemetry data by accessing (e.g., snooping) the error messages and extracting the payload data of the error message.

One example of the error messages is an Internet Control Message Protocol (ICMP) error message that may be sent to a source network device when a packet is dropped. As part of ICMP, an access switch may receive an ICMP error message reported in response to a packet of traffic being dropped. The access switch may snoop the contents when passing along the ICMP error message to the source network device. Thus, an access switch may generate the MOD telemetry data through snooping the ICMP error message and extracting data from the error message.

In some examples of the present disclosure, an access device includes interface circuitry that establishes one or more communication links with a networking device, a client device, and a network management system. The one or more communication links may be associated with an overlay network. The access device includes at least one processing resource. The at least one processing resource receives, via the interface circuitry, a packet from the client device. The at least one processing resource receives, via the interface circuitry, an error message from the networking device. The error message is associated with the packet being dropped while in transit. For example, the error message may be the ICMP error message. The at least one processing resource may receive the error message through snooping the error message. The at least one processing resource extracts payload data from the error message. The payload data includes data related to the packet. The at least one processing resource generates telemetry data based on the payload data. The at least one processing resource reports, via the interface circuitry, the telemetry data to the network management system. The at least one processing resource may transmit, via the interface circuitry, the error message to the client device. In doing so, the access device repurposes the payload data from the error message when reporting the telemetry data to the network management system, which may enable less complex integration into deployed networks relative to systems and methods that use networking devices individually reporting MOD telemetry data to the network management system.

For example, there is a standards body standardizing the technical mechanism by which a networking device reports the error message to the client device, which may negate integration issues arising from the networking device generating telemetry data for reporting to the network management system. Maintaining configurations on a single access switch to enable telemetry reporting is much less complex to initiate and manage. The technical mechanism by which to generate the error message is already in place in many network deployments and standardized, reducing complexity of deploying this technology in a multi-vendor network deployment. Moreover, installing a single access switch to support MOD telemetry is cheaper than installing many networking devices as it is a relatively new commercial offering in network deployments. Leveraging a single access switch to provide telemetry based on an existing mechanism of error message reporting may increase a speed of adoption due to reducing a need to change a core configuration of networking devices previously used to enable MOD telemetry.

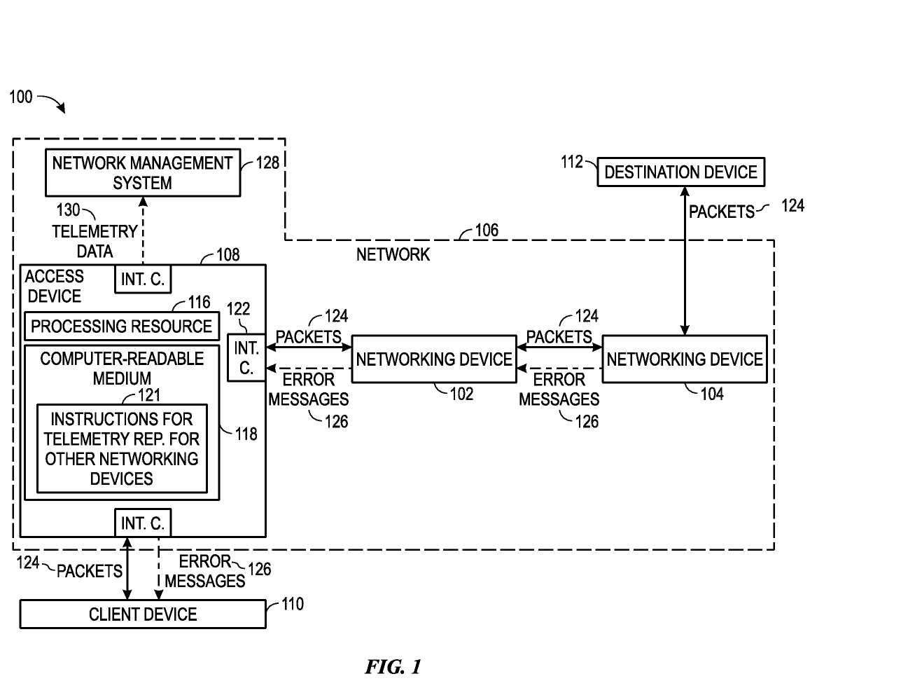

With the foregoing in mind, FIG. 1 is a diagram illustrating a system 100 that includes networking device 102 and networking device 104. The networking device 102 and the networking device 104 may connect to each other through one or more additional networking devices (not illustrated) and form at least a portion of a network 106.

An access device 108 may be a networking device that connects a client device 110 to the network 106. The access device 108 may monitor telemetry from server devices and/or other network devices.

The client device 110 may be any suitable device. For example, the client device 110 may be a device that makes data requests or services from a remote server or a server device (e.g., a remote server) that provides data in response to data requests from another networking device (e.g., a client device). The client device 110 may represent a system of one or more devices accessing the network 106.

The network 106 may be formed from multiple electronic devices and/or connections between devices through which communication may be made between the client device 110, the access device 108, the networking device 102, the networking device 104, and/or other networking devices of the network 106. The network 106 may be an entire network on its own and/or may be a network segment that is a part of a larger network. In some implementations, the access device 108 may be part of the network 106 while in other implementations the access device 108 may be outside of the network 106 while providing connectivity to the network 106 for the client device 110. The networking device 102 and the networking device 104 may be part of the network 106 or may be outside of the network 106 but may communicate with each other through one or more devices (e.g., switches, routers, etc.) in the network 106. For instance, the networking device 102 and the networking device 104 may be in different networks that use the network 106 as a communication pathway between their respective networks.

The client device 110 may communicate with a destination device 112 through sending and receiving communications (based on packets 124 described below) via the network 106. In some implementations, the client device 110 may initiate a request for a connection to a destination device 112 or other networking device through the network 106. The destination device 112 may be any suitable endpoint device. For example, the destination device 112 may be part of the network 106 as another networking device. The destination device 112 may be a server device from which the client device 110 may request access, services, and/or data.

Some operations associated with the network 106 may be respectively enabled through one or more processing resources, such as processing resource 116 of the access device 108. Each respective processing resource of the processing resources may be any suitable processor, computer, application specific integrated circuit (ASICs), or the like. Examples of the processing resource include one or more field programmable gate arrays (FPGAs), a personal computing device or user equipment, a desktop computer, a laptop computer, a server, a virtual computing system, such as a virtual machine, a container, a pod, or the like, or any suitable computing system.

Some operations associated with the network 106 may be respectively enabled through data stored in one or more computer-readable mediums, such as computer-readable medium 118 of the access device 108. The one or more processing resources may be operably coupled with the computer-readable mediums to facilitate the use of the one or more processing resources to implement various stored programs. Such programs or instructions executed by the one or more processing resources may be stored in the computer-readable mediums, which may include any suitable article of manufacture that includes one or more non-transitory and computer-readable media at least collectively storing the instructions or routines. For instance, one or more of the computer-readable mediums may include a storage device, such as a Non-Volatile Memory Express (NVMe) device, a hard disk drive (HDD), a solid-state drive (SSD), an optical drive, flash memory, read-only memory (ROM), or any combination thereof. The computer-readable mediums may include any suitable class of memory devices, such as a double data rate type 5 (DDR5) synchronous dynamic random-access memory (SDRAM) device, double data rate type 4 (DDR4) SDRAM device, low-power double data rate (LPDDR) SDRAM device, another suitable type of memory device, or any combination thereof. In some implementations, the one or more processing resources may store policy tables, flow tables, settings, and/or other data used in controlling how the processing resources, and thus the respective networking devices of the system 100 behave in generating or transmitting packets 124, error messages 126, or, when referring to the access device 108, the telemetry data 130. For example, the computer-readable medium 118 of the access device 108 may store instructions 121 that, when executed by the processing resources 116 of the access device 108, may enable the access device 108 to perform telemetry reporting for the access device 108 and for other networking devices of the network 106.

As previously mentioned, by the access device 108 performing telemetry reporting for other networking devices (e.g., networking devices 102 or 104), telemetry reporting may be enabled for these other networking devices without causing updates to integral parts of the network 106. For instance, if the other networking devices are core routers and/or other integral parts of the network 106, administrators may be unwilling to update the other networking devices to enable telemetry as such updates may render a large portion or even the entire network 106 inoperable if the update fails or even causes temporary downtime for the other networking devices. As another example, the computer-readable medium of the destination device 112 may store instructions that, when executed by the processing resource of the destination device 112, may enable the destination device 112 to execute an application to provide data or services to the client device 110 based on an application.

Communications may occur between devices of the network 106 through respective interface circuitries, such as interface circuitry 122 of the access device 108. For example, interface circuitry may include one or more configurable components that establish one or more communication links with the networking device 102, the networking device 104, the client device 110, and/or a network management system 128, where the communications are exchanged over the communication links. The communications may be wired or wireless communications. The interface circuitries may include input-output (I/O) interfaces that enable other remote devices and/or a user to transmit data to and/or receive data from the computing system 100. The interface circuitries are included in multiple devices (e.g., the networking devices 102 and 104) to enable coupling and communication between the devices. The interface circuitries may include, for example, one or more network interfaces for a personal area network (PAN), such as a Bluetooth network, for a local area network (LAN) or wireless local area network (WLAN), such as an IEEE 802.11x Wi-Fi network, an IEEE 802.15.4 wireless network, an Ethernet network, and/or for a wide area network (WAN), such as a cellular network. The interface circuitries may additionally or alternatively include one or more interfaces for, for example, broadband fixed wireless access networks (WiMAX), mobile broadband Wireless networks (mobile WiMAX), and so forth. The interface circuitries may include additional interface types, such as a Universal Serial Bus (USB) interface, a coaxial cable interface, or a combination thereof. For example, communication over the network 106 via the interface circuitries may be performed in accordance with various communication protocols including, but not limited to, Transmission Control Protocol and Internet Protocol (TCP/IP), User Datagram Protocol (UDP), IEEE 802.11, and/or cellular communication protocols. The communication over the network 106 may be enabled via wired technologies using copper wires (e.g., Ethernet or Powerline technologies), optical communication wires, or the like. The communication over the network 106 may be enabled via wireless technologies like WI-FI® communication technologies, cellular communication technologies, BLUETOOTH® communication technologies, or the like. In some systems, the network 106 may be enabled through a combination of wired communication technologies and wireless communication technologies. The interface circuitries may include hardware or software to enable the use of wired or wireless communications. For example, the interface circuitry of the client device 110 may include hardware that enables a wireless connection, such as radio frequency front end circuitry and antenna circuitry, with the access device 108. For example, the interface circuitry of the access device 108 may include hardware that enables a wireless connection with the client device 110, such as radio frequency front end circuitry and antenna circuitry. Additionally or alternatively, the interface circuitry 122 of the access device 108 may include hardware that enables a wired connection with the networking device 102, such as a copper wire-based bus connection and a general-purpose input/output. Similarly, the interface circuitry of the networking device 102, the networking device 104, and the destination device 112 may include any suitable combination of hardware or software to enable wired or wireless communications through the network 106.

The client device 110 may communicate with one or more networking devices, like networking devices 102 or 104, the access device 108, the destination device 112, or other suitable networking devices associated with the network 106. In doing so, the client device 110 may transmit packets 124 to the network 106. The client device 110 may generate the packet to communicate a request, audio data, image data, video stream data, application data, telecommunication data, or the like to the destination device 112. A respective packet of the packets 124 may include payload data and a header, which may include a source internet protocol address, a destination internet protocol address, and other suitable header information that guides the routing or transmission of the payload data to a destination through the network 106. The network 106 may transmit the packets 124 to the destination device 112 through one or more networking devices forwarding and routing the packets 124 according to the header information.

While in transit, one of the networking devices of the network 106 may drop one or more of the packets 124. For example, the networking device may decide to drop the packet. In another example, a broken connection, such as a broken Ethernet cable, may drop the packet between networking devices without a respective networking device dropping the packet. When the packet is dropped, at least one of the networking devices may generate and send one or more error messages 126 to a client device that originally generated the packet that was dropped in transit to the destination device 112 or another networking device.

The error messages 126 may include type data, code data, checksum data, pointer data, and an original internet protocol (IP) datagram as a payload. The error message may indicate an identifier of the networking device that generated the error message and/or dropped the packet. The error message may indicate a reason behind the dropping of the packet, such as an authentication error. The network 106 may route the error messages 126 to the access device 108, which routes the error messages 126 to the client device 110 that originally sent the packet dropped in transit. One example of the error messages 126 is an Internet Control Message Protocol (ICMP) error message.

The system 100 may include a network management system 128. The network management system 128 may include a computer-readable medium and a processing resource similar to the earlier described networking devices. The computer-readable medium of the network management system 128 may include instructions that, when executed by the processing resource of the network management system 128, cause the processing resource to perform operations based on telemetry data 130 received from the network 106. For example, the network management system 128 may analyze network drops to diagnose network 106 performance changes over time, to identify relatively more problematic networking devices/routes, to identify bottleneck locations in the network 106, to identify possible spoofing or other types of attacks that may be coordinated between multiple networks (including the network 106), or the like. The network management system 128 may receive telemetry data 130 relative to one or more networks, which may include the network 106. The network management system 128 may store the telemetry data 130 over time to track and analyze changes in network 106 performance. The network management system 128 may compare performance changes over time of the network 106 to changes of one or more other networks. Doing so may help the network management system 128 perform root cause analysis, suggest maintenance operations, or the like.

To elaborate further on the telemetry data 130, the telemetry data 130 indicates to the network management system 128 reasons why a packet of the packets 124 was dropped by a networking device (e.g., explanation data), what traffic the dropped packet was transmitted with (e.g., traffic identifier), a timestamp of the occurrence (e.g., a timestamp), and a networking device responsible for dropping the packet (e.g., a networking device address) or the networking device nearest in proximity to the drop of the packet (e.g., in the case of the broken connection this may be the networking device that most recently routed the packet). One example of the telemetry data 130 is mirror on forwarding drop (MOD) telemetry data.

In some systems, a networking device that drops a packet of the packets 124 may report telemetry data. The networking device may report the telemetry data on a per-network-device basis. Implementing telemetry data reporting on this per-network-device basis may lead to slow or hesitant adoption and/or consume relatively high amounts of resources (e.g., bandwidth) when deploying and maintaining respective networking device configurations. One reason that network administrators may be hesitant in such adoption is that deploying telemetry reporting on all networking devices may demand updates to core network components (e.g., spine routers and core configurations). Generally, network administrators may be hesitant to make any changes to such components as such updates may cause failures that may stop the entire network from functioning with potential impacts of such downtimes being costly. These issues are even more greatly exacerbated due to the risk of updates to some core network components to irreversibly render such devices unusable, also known as “bricking” the core network components. Any periods where the core network components cannot be used may render large portions of the network 106 or even the entire network 106 unusable.

To efficiently use network resources while enabling telemetry data reporting, reporting systems and methods may use access devices 108 (rather than core components) to generate and report the telemetry data 130 based on error messages 126, even when other devices generate the error messages 126 and the error messages 126 are destined for other devices. This enables such telemetry reporting, like MOD telemetry reporting, without demanding updates to network core components.

Indeed, there is overlap in the information reported in the error messages 126 and the information reported as telemetry data. Thus, the access device 108 may generate the telemetry data 130 by accessing (e.g., snooping), or otherwise obtaining error messages 126 and extracting the payload data of the error messages 126. Snooping may involve monitoring or access the error message without changing or impacting the use of the error message by the client device 110 error message. For example, as part of ICMP, the access device 108 may receive an ICMP error message reported in response to a packet of traffic (e.g., of the packets 124) being dropped. The access device 108 may snoop the contents when passing along the ICMP error message to the client device 110. The access device 108 may program its datapath, including the interface circuitry 122, to send a copy of the error message to the processing resource 116 in response to the interface circuitry 122 determining that the destination IP address matches a respective IP address of the locally attached client device 110. Data tables may be accessible to a subset of the processing resource 116 corresponding to the interface circuitry 122, which may enable the interface circuitry 122 to identify when to copy the error message. Thus, the access device 108 may generate the telemetry data 130 through snooping the ICMP error message and extracting data from the error message. Since the traffic to and from the client device 110 with the network 106 travels through the access device 108, the access device 108 may reliably report telemetry data for its client devices. Likewise, if each access device 108 were to similarly report telemetry data for each client device, the network 106 may reliably report all telemetry data for core network components without implementing telemetry reporting on the core network components themselves.

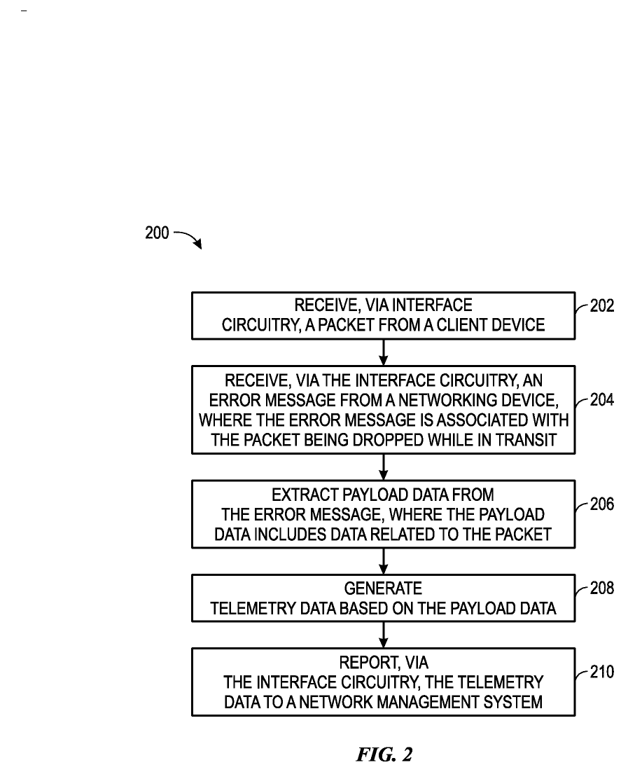

FIG. 2 is a flow diagram for a process 200 that may be implemented in circuitry of an access device, where the access device 108 of FIG. 1 may be an example of the access device of FIG. 2. For instance, at least some of the steps may be performed using a processing resource of an access device, such as the processing resource 116 of the access device 108. An access device receives, via interface circuitry, a packet from a client device (block 202). For example, one of the packets 124 of FIG. 1 may be an example of the packet of FIG. 2. The client device 110 of FIG. 1 may be an example of the client device of FIG. 2. The packet may be a respective packet of multiple packets transmitted as traffic throughout a network, where the network 106 of FIG. 1 may be an example of the network. The packet may be received at an input port of the interface circuitry from the client device. The client device may generate and transmit the packet to communicate data of the packet to a destination device, where the destination device 112 of FIG. 1 may be an example of the destination device.

During transit, the packet is dropped somewhere in the network that causes an error message to be generated. The access device receives, via the interface circuitry, an error message from a networking device (block 204), where the error message is associated with the packet from block 202 being dropped while in transit to the destination device. The error message may be an example of a respective error message of the error messages 126 of FIG. 1. When a networking device, the destination device, or the access device drops the packet, it generates and sends an error message back to the device that generated the packet, which here is the client device. The error message may include a payload data and a header with an identifier of the networking device that generated the error message and dropped the packet. If the packet is dropped by a networking device associated with an overlay network, the access device may receive, based on the processing resource, the error message from a virtual tunnel end point (VTEP). If the packet is dropped by a networking device that is not the access device in a network without an overlay network, such as occurs in a packet forwarding drop occurring in the network between the access device and the destination device, the access device may access (e.g., snoop) the error message in transmit to the client device.

To elaborate further on drop reasons, the error message may indicate a reason behind the dropping of the packet. Any suitable reason may be used, and definitions of the drop reasons may be governed by a third-party standardization body, such as Internet Assigned Numbers Authority (IANA). Several examples are described herein of drop reasons and these examples are intended as exemplary rather than exhaustive. As a first example, a reason for a drop may be associated with a Time-to-Live (TTL) as a TTL-0 reason, which may be mapped to an ICMP error of ICMP Type-11 (time to live exceeded) that limits a number of hops for a packet before it is discarded to prevent a packet from looping unendingly through the network. As a second example, a reason for a drop may be a Layer 3 (L3) destination miss (no route), which may be mapped to an ICMP error of ICMP Type-3/Code-6 (destination unreachable) when a networking device cannot find an available route to an indicated destination. As a third example, a reason for a drop may be a maximum transmission unit (MTU) violation, which may be mapped to an ICMP error of ICMP Type-3/Code-4 (fragmentation needed) indicating that a packet is too large, demanding splitting the packet up into smaller packets. As a fourth example, a reason for a drop may be an access control list (ACL)/policy drop, which may be mapped to an ICMP Type-3/Code-9 (communication with network admin prohibited) indicating an unauthorized communication. As a fifth example, a reason for a drop may be an IP checksum or framing issues, which may be mapped to an ICMP error of ICMP Type-12/Code-2 (parameter problem - Bad length) indicating that there is an error with the data or frame of the packet. As a sixth example, a reason for a drop may be a Unicast Reverse Path Forwarding (uRPF) violation, which may be mapped to an ICMP error of ICMP Type-3/Code-5 (source route lookup error) indicating a spoofed source IP address. As a seventh example, a reason for a drop may be a meter threshold violation drop, which may be mapped to an ICMP error of ICMP Type-3/Code-9 (communication with network admin prohibited). When a networking device drops a packet or is relatively proximate to the drop of the packet (e.g., in the broken connection example), this networking device may be referred to herein as the dropping networking device for ease of discussion in some places. The dropping networking device sends a copy of the dropped packet to its processing resource, which obtains an IP address of the client device that generated the packet. The dropping networking device sends an error message back to the client device of the IP address with a portion of the dropped packet as error message payload data (e.g., original IP datagram). The portion of the dropped packet sent back may include a threshold amount of data, such as an initial N bytes of data of the dropped packet, which may serve to notify the client device as to which packet of the packets of traffic was dropped in transmission.

The access device extracts payload data from the error message, where the payload data may include data related to the packet from block 202 (block 206). For example, the error message may include type data, code data, checksum data, pointer data, and/or the original IP datagram as the payload data. The access device may access the error message before, during, and/or after the error message is transmitted to the client device to obtain information that can be reported as telemetry data to a network management system, which may be an example of the network management system 128 of FIG. 1. The access device may extract the payload data from the error message (or a copy of the error message). The payload data indicates an amount of data (e.g., 5-tuple) indicating a reason for which the packet was dropped. The access device may obtain the drop reason through reverse mapping from an error type/code to a drop reason based on the examples at block 204, where a table in the computer-readable medium of the access device may indicate the mapping between the error type/code to the drop-reason that the processing resource may reference when identifying the drop reason. Moreover, the access device may obtain the source IP address of the networking device that generated the error message.

The access device generates telemetry data based on the payload data (block 208). The access device may generate the telemetry data based on encoding the type of drop in the telemetry data, where the payload data of the error message may include a type of drop. The telemetry data may indicate the IP address of the client device that generated the error message, here the client device, timestamps for a time of drop and/or forwards of the packet, the network segment or networking device where the packet was dropped, and/or the drop reason.

The access device reports, via the interface circuitry, the telemetry data to the network management system (block 210). To report, the access device may update a cache in the computer-readable medium to indicate the IP address of the client device that generated the error message, here the client device, and the drop reason and/or any other information about the packet and/or the drop that may be deemed useful in analyzing network performance. In some cases, the access device may update the cache to indicate a 5-tuple and/or other packet information from the error message. The access device may report the telemetry data to the network management system by pushing an updated cache to the network management system, by generating a packet with the updated data for reporting to the network management system, or another suitable reporting method. In some systems, the access device transmits, via the interface circuitry, the error message to a client device, such as to or through the client device that transmitted the packet at block 202. For example, the access device may forward the error message to the client device.

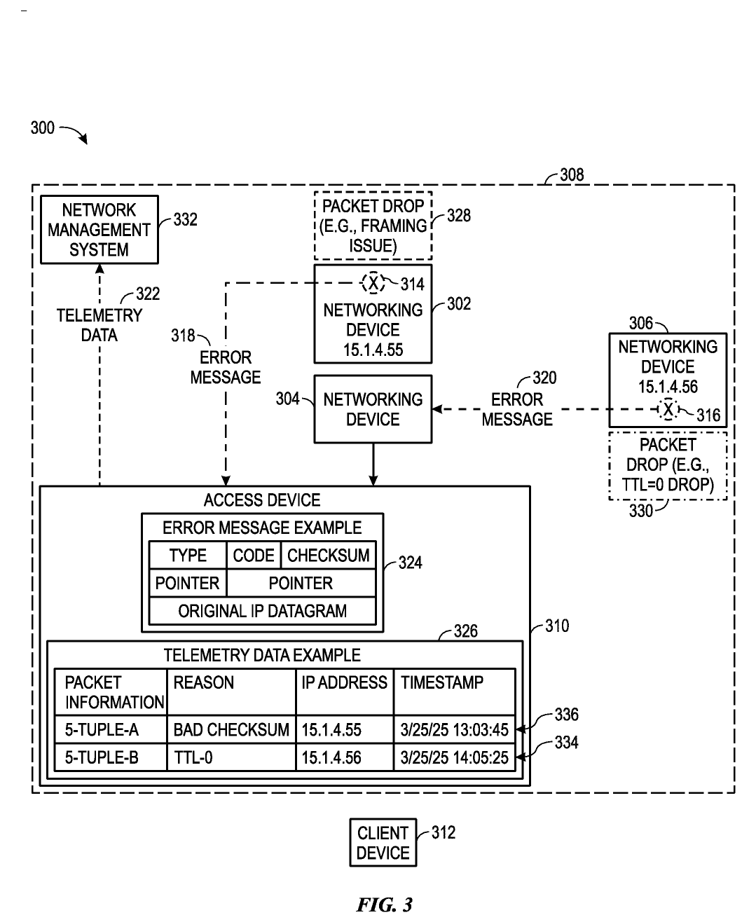

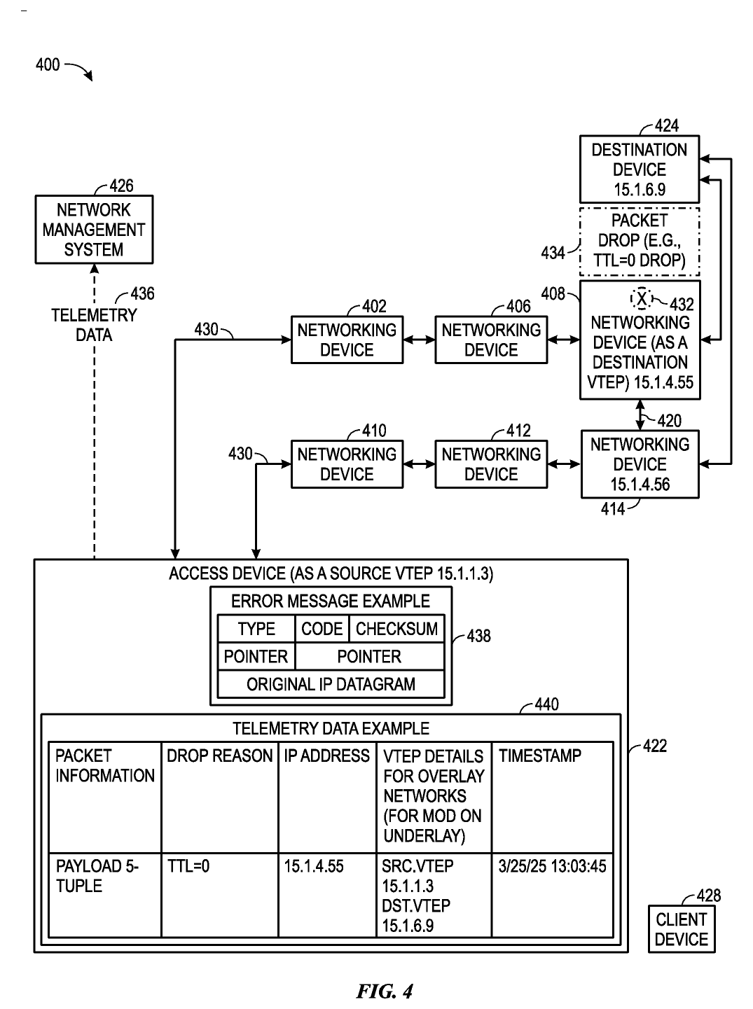

FIG. 3 is a diagram illustrating a system 300 that includes networking device 302, networking device 304, and networking device 306. The networking device 302, networking device 304, and networking device 306 may be examples of the networking device 102 of FIG. 1 and/or the networking device 104 of FIG. 1. The networking device 302, networking device 304, and networking device 306 may connect to each other through one or more additional network devices (not illustrated) and form at least a portion of a network 308, which may be an example of the network 106 of FIG. 1. Here, for simplicity of discussion, the network 308 may be a network that does not use overlay networks or virtual logical networks. An overlay network that operates based on an underlay network, one or more tunnels, and encapsulation operation is described further at least relative to FIG. 4.

An access device 310 may be a networking device that connects a client device 312 to the network 308. The access device 310 may be an example of the access device 108 of FIG. 1.

The client device 312 may generate one or more packets to be transmitted via the network 308 to a destination device (not illustrated) like the destination device 112 of FIG. 1. The client device 312 may be an example of the client device 110 of FIG. 1.

A networking device of the network 308 may drop one of the packets while in transit to the destination device. The illustrated example may be an example of a packet forwarding drop. For example, the networking device 302 may drop a first packet, where the dropped first packet is represented by an indicator 314. As another example, the networking device 306 may drop a second packet, where the dropped second packet is represented by an indicator 316. The dropping networking device may generate an error message in response to dropping the packet. For example, the networking device 302 generates an error message 318 in response to dropping the first packet. Similarly, the networking device 306 generates an error message 320 in response to dropping the second packet. The dropping networking device transmits the generated error message toward the client device through the access device 310. Here, the client device is the client device 312 as the client device 312 originally generated the first packet and the second packet.

The access device 310 may snoop the generated error messages to access the payload of the error messages transmitted through it onto the client device 312. The access device 310 that the client device 312 is attached to may access (e.g., snoop) error messages destined to IP addresses of its locally attached devices, such as client devices and/or server devices. The access device 310 may identify its locally attached clients (or servers) based on address resolution protocol (ARP) table entries, media access control (MAC) address table entries, and IP address tracking table entries, or the like. The access device 310 may use one or more of the tables to manage a list of locally attached devices and the respectively assigned IP addresses of the locally attached devices. The access device 310 may program its datapath, including interface circuitry, to send a copy of the error message to its processing resource in response to the interface circuitry determining that the destination IP address matches a respective IP address of the locally attached client device. The tables may be accessible to processing resources corresponding to the interface circuitry, which may enable the interface circuitry to identify when to copy the error message to the processing resource. After snooping, the access device 310 may repurpose information of the error message to report as telemetry data 322.

Inset data table 324 illustrates an example of information that the error messages may include. For example, the error message 318 and/or the error message 320 may respectively include a type data, code data, checksum data, pointer data, and/or an original internet protocol (IP) datagram as payload data. When an error message is an ICMP error message, the type data may be 8 bits that indicate an ICMP type, the code data may be 8 bits that indicate an ICMP subtype, and the checksum data may be 16 bits that indicate an Internet checksum for error checking, which may be calculated from an ICMP header and data with value 0 substituted for this field. For example, the type data may indicate “3” corresponding to “Type 3 – Destination Unreachable” and the code data may indicate “2” corresponding to “Code 2 – Protocol Unreachable.” When the error message is the ICMP error message, the payload data may include an additional 32 bits of the header of the error message, which may include a four-byte field with contents that vary based on the type data and code data. The payload data may include a data section that includes a copy of an IPv4, or other suitable IP header, and at least a portion of data of the dropped packet. For example, the payload data may include the first 8 bytes of data from the dropped packet. The error message may indicate an identifier of the dropping networking device that generated the error message through the copy of the IPv4, or other suitable IP header. The error message may include a reason behind the dropping of the packet. For example, payload data of the error message 318 may include the reason behind the dropping of the packet as a “packet drop (e.g., framing issue)” (block 328). As another example, the error message 320 may include the reason behind the dropping of the packet as a “Packet Drop (e.g., TTL=0 Drop)” (block 330).

Inset data table 326 illustrates an example of information that the telemetry data 322 may include. For example, the telemetry data 322 may include packet information data, reason data, IP address data, timestamp data, and/or other information as a payload. The access device 310 may store the information of the inset data table 326 in a MOD cache in its computer-readable medium, such as the computer-readable medium 118 of the access device 108 of FIG. 1. The telemetry data 322 may report to a network management system 332 data extracted from error messages received by the access device 310. The network management system 332 may be an example of the network management system 128 of FIG. 1.

Rows of the inset data table 326 may correspond to data extracted from different error messages. For example, row 334 corresponds to the data that the access device 310 extracted from the error message 320, and row 336 corresponds to the data that the access device 310 extracted from the error message 318. In performing the extraction, the access device 310 may map error message reasons for the drop to telemetry reasons for the drop. For example, the access device 310 may extract the type data and the code data from the error message 318 as “Type 12” (“Type 12 – Parameter Problem”) and “Code 2” (“Code 2 – Bad Length”) and may map the reason for the drop as a “Bad Checksum” reason for purposes of reporting the drop in the telemetry data 322. As another example, the access device 310 may extract the type data and the code data from the error message 320 as “Type 11” (“Type 11 – Time Exceeded”) and “Code 0” (“Code 0 – Time to Live exceeded in Transit”) and may map the reason for the drop as a “TTL=0” reason for purposes of reporting the drop in the telemetry data 322. The access device 310 may include IP addresses of the dropping networking device in the telemetry data 322. For example, in the row 336, the networking device 302 is indicated through its IP address of “15.1.4.55” and, in the row 334, the networking device 306 is indicated through its IP address of “15.1.4.56.” The access device 310 may include packet information data of the dropped packet in the telemetry data 322. For example, in the row 336, packet information data of “5-TUPLE-A” may indicate the 5-tuple flow of the dropped first packet and, in the row 334, packet information data of “5-TUPLE-B” may indicate the 5-tuple flow of the dropped second packet.

FIG. 4 is a diagram illustrating a system 400 that includes networking device 402, networking device 406, networking device 408, networking device 410, networking device 412, and networking device 414. The networking device 402, networking device 406, networking device 408, networking device 410, networking device 412, and networking device 414 may be examples of the networking device 102 of FIG. 1 and/or the networking device 104 of FIG. 1. A network (not numbered for ease of illustration), similar to the network 106 of FIG. 1, may be enabled through the interconnections and communications between the networking device 402, networking device 406, networking device 408, networking device 410, networking device 412, and networking device 414. The networking device 402, networking device 406, networking device 408, networking device 410, networking device 412, and networking device 414 may connect to each other through one or more additional network devices (not illustrated) and form at least a portion of the network.

Here, the network may include an overlay network that uses an underlay network, one or more tunnels, encapsulation operations, or the like. Hardware, wired connections, and/or wireless connections supporting use of the overlay network may be considered an underlay network. For example, a tunnel may be implemented through the connection shown as a solid arrow 420 of the underlay network between the networking device 408 and the networking device 414, where the solid arrow 420 may represent a wired or wireless connection between respective interface circuitries of the networking devices 408 and 414 that may be examples of interface circuitries of FIG. 1. An example of a tunnel may be an overlay tunnel as used in virtual extensible local area networks (VxLANs) that may operate based on generic routing encapsulation (GRE), such as layer 3 GRE (L3GRE) operations.

It is noted that access device 422 may be an example of the access device 108 of FIG. 1, the access device described relative to FIG. 2, the access device 310 of FIG. 3, or the like. It is noted that destination device 424 may be an example of the destination device 112 of FIG. 1, the destination device described relative to FIG. 2, the destination device described relative to FIG. 3, or the like. It is noted that network management system 426 may be an example of the network management system 128 of FIG. 1, the network management system described relative to FIG. 2, the network management system 332 of FIG. 3, or the like. It is noted that client device 428 may be an example of the client device 110 of FIG. 1, the client device described relative to FIG. 2, the client device 312 of FIG. 3, or the like. Systems and methods described relative to FIG. 4 may implement telemetry reporting for other networking devices at the access device 422 when used in an overlay network or another suitable network that operates based on encapsulation operations.

Describing example operations of the overlay network, the access device 422 may be a VxLAN Tunnel Endpoint (VTEP). In such systems, the access device 422 as a source VTEP encapsulates traffic from the client device 428 and sends the encapsulated traffic over an underlay network to a destination VTEP. The remote VTEP may be a corresponding VxLAN device or other suitable device operating based on L3GRE operations or other suitable tunnelling operations. If there is any drop in the underlay network, that is, if a networking device drops the packet of the encapsulated traffic, the dropping networking device that is dropping the packet generates an error message towards the source VTEP. The error message may be an ICMP error message, which may be similar to error messages 126 of FIG. 1. The error message may be generated toward the source VTEP because the IP address of the packet that indicates the source of the packet (e.g., an outer-Src-IP) is in this case the IP address of the source VTEP based on the encapsulation operations performed by the source VTEP (e.g., access device 422).

For example, a processing resource of the access device 422 may transmit, via interface circuitry of the access device 422, the packet of traffic over the overlay network toward the destination device 424 (as the destination VTEP) as part of encapsulated traffic (represented through connections 430). The networking device 402 may receive the packet from the access device 422 as part of the encapsulated traffic and may transmit the packet to the networking device 406 as part of the encapsulated traffic. The networking device 406 may receive the packet from the networking device 402 as part of the encapsulated traffic and may transmit the packet onto the networking device 408 as part of the encapsulated traffic. The networking device 408 may drop the packet, which is represented by an indicator 432. For example, the drop reason of the drop may correspond to a “Packet Drop (e.g., TTL=0)” (block 434). The networking device 408, in response to dropping the packet, may send an error message to the access device 422 (as a source VTEP). The networking device 408 may send the error message as part of the encapsulated traffic and/or outside of a corresponding tunnel. The networking device 408 may generate the error message to include at least a portion of the original packet that was dropped. The access device 422 may lift the error message to its processing resources. In some cases, the access device 422 may access (e.g., snoop) the error message to obtain the payload data of the error message. For example, the type of drop may include a packet forwarding drop in a portion of an underlay network, and where the processing resource may receive the error message through snooping the error message. The processing resources of the access device 422 may decapsulate the error message and cause transmission of the decapsulated error message to the client device 428, which may be outside the overlay network. Decapsulating the error message may expose the information of the error message to the access device 422, which it may use to generate telemetry data 436. Since the access device 422 decapsulates the error message, the access device 422 may have access to data of the error message even in implementations with overlay networks. For example, the access device 422 may extract the type data and the code data from the error message as “Type 11” (“Type 11 – Time Exceeded”) and “Code 0” (“Code 0 – Time to Live exceeded in Transit”) and may map the reason for the drop as a “TTL=0” reason for purposes of reporting the drop in the telemetry data 436.

Inset data table 438 illustrates example information that the error messages may include, which may be similar to inset data table 324. For example, the error message may include a type data, code data, checksum data, pointer data, and/or an original internet protocol (IP) datagram as a payload. The access device 422 may identify additional information than what is in the initial payload 5-tuple information from the error message of the underlay network as the initial payload is the outer-IPs, which may be further enhanced by the access device 422 to identify which applications of the client device 428 are impacted. The dropping networking device that generated the error message may send up to a maximum size (e.g., 72 bytes) of the original packet data as the error message payload data. Some systems may send a smaller amount (e.g., 8 bytes) of the payload as part of the error messages, which may be insufficient for gleaning sufficient telemetry data from overlay network payload information meaning that up to the maximum size may be used at least for some protocols, such as native ICMPv6 protocols. Some networking devices may support Extended ICMP to Support Multi-Part Messages and MTU propagation over EVPN Overlay networks, which may enable sending relatively larger payload information elements back to the source VTEP (e.g., access device 422) of the traffic that was dropped.

Inset data table 440 illustrates example information that the telemetry data 436 may include, which may include some similar data as inset data table 326. The access device 422 may store the information of the inset data table 440 in a MOD cache in its computer-readable medium, such as the computer-readable medium 118 of the access device 108 of FIG. 1. The access device 422 may glean original overlay network payload information by skipping past the underlay network headers and extracting the overlay network payload information from the error message. The telemetry data 436 may include the payload 5-tuple (e.g., 5-tuple flow identifier) as the packet information data, drop reason data mapped from type data and code data of the error message, the dropping networking device IP address, and the source and destination details for the overlay network that dropped the packet, such as the source VTEP IP address and the destination VTEP IP address. For example, the access device 422 may generate the telemetry data 436 as including a payload 5-tuple as the packet information data, “TTL=0” as the drop reason data, “15.1.4.55” as the dropping networking device IP address, “15.1.1.3” as the source VTEP IP address (corresponding to the IP address of the access device 422), and “15.1.6.9” as the destination VTEP IP address (corresponding to the IP address of the destination device 424).

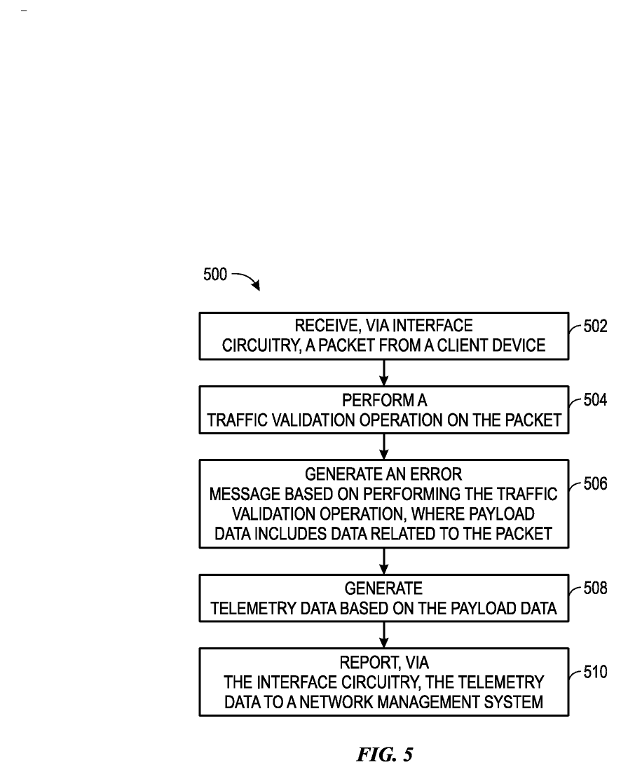

FIG. 5 is a flow diagram for a process 500 that may be implemented in circuitry of an access device, where the access device 108 of FIG. 1 may be an example of the access device of FIG. 5. For instance, at least some of the steps may be performed using processing resources 116 of the access device 108. The access device receives, via interface circuitry, a packet from a client device (block 502). The interface circuitry of FIG. 1 may be an example of the interface circuitry of FIG. 5. A packet of the packets 124 of FIG. 1 may be an example of the packet of FIG. 5. The client device 110 of FIG. 1 may be an example of the client device of FIG. 5. The packet may be a respective packet of multiple packets transmitted as traffic throughout a network, where the network 106 of FIG. 1 may be an example of the network of FIG. 5. The access device may receive the packet from the client device at an input port of interface circuitry of the access device. The client device may generate and transmit the packet to communicate data of the packet to a destination device, where the destination device 112 of FIG. 1 may be an example of the destination device of FIG. 5. Block 502 describes a client device transmitting the packet and it should be understood that operations of the process 500 may be similarly applied to a different type of networking device, like a server device.

The access device performs a traffic validation operation on the packet (block 504). The access device may validate traffic from the client device from a security inspection standpoint. If the access device decides not to and/or cannot validate a packet of the traffic, the access device may drop the packet, which may be considered a network access drop. Example drop reasons of a network access drop include an IP/MAC-lockdown drop, a router-advertisement (RA) filter (RA-filter) drop, or the like. The IP/MAC-lockdown drop may relate to the access device dropping one or more packets in response to identifying the one or more packets as spoofed traffic. The access device may also re-authenticate the client device to verify credentials of the client device before permitting the one or more packets to be re-transmitted into the network (after being dropped). For example, the access device performing IP/MAC-lockdown operations may ensure that traffic from the client device is pinned or assigned to a port. Should the access device receive a new packet with the same IP/MAC address as the original traffic from the client device at different port, the access device identifies the new packet as possibly part of spoofed traffic, drops the new packet, and causes the client device to undergo re-authentication operations. The RA-filter drop may relate to policies stored on the access device that, when enforced, may permit or deny RA advertisements based on the filtering configuration set by the policies enforced on the access device.

The access device generates an error message based on performing the traffic validation operation, where payload data of the error message includes data related to the packet (block 506). The error messages 126 of FIG. 1 may be an example of the error message of FIG. 5. When the access device decides to drop the packet for one or more of the above reasons, the access device may directly insert an entry into a cache table, like a MOD cache table, with the network device IP address set to the IP address of the access switch. The access device may include data in the entry based on data of the error message.

The access device generates telemetry data based on the payload data (block 508). The telemetry data 130 of FIG. 1, the telemetry data described relative to FIG. 2, the telemetry data 322 of FIG. 3, or the like may be examples of the telemetry data of FIG. 5. For example, the access device may generate the telemetry data to include packet information data, reason data, IP address data, and/or timestamp data based on the payload data of the error message.

The access device reports, via the interface circuitry, the telemetry data to a network management system (block 510). The network management system 128 of FIG. 1, the network management system described relative to FIG. 2, the network management system 332 of FIG. 3, the network management system 426 of FIG. 4, or the like may be examples of the network management system of FIG. 5. The access device may export the MOD cache table to the network management system. This reporting of the telemetry data may occur in addition to the access device generating and sending the error message toward the client device that was the source of the dropped packet.

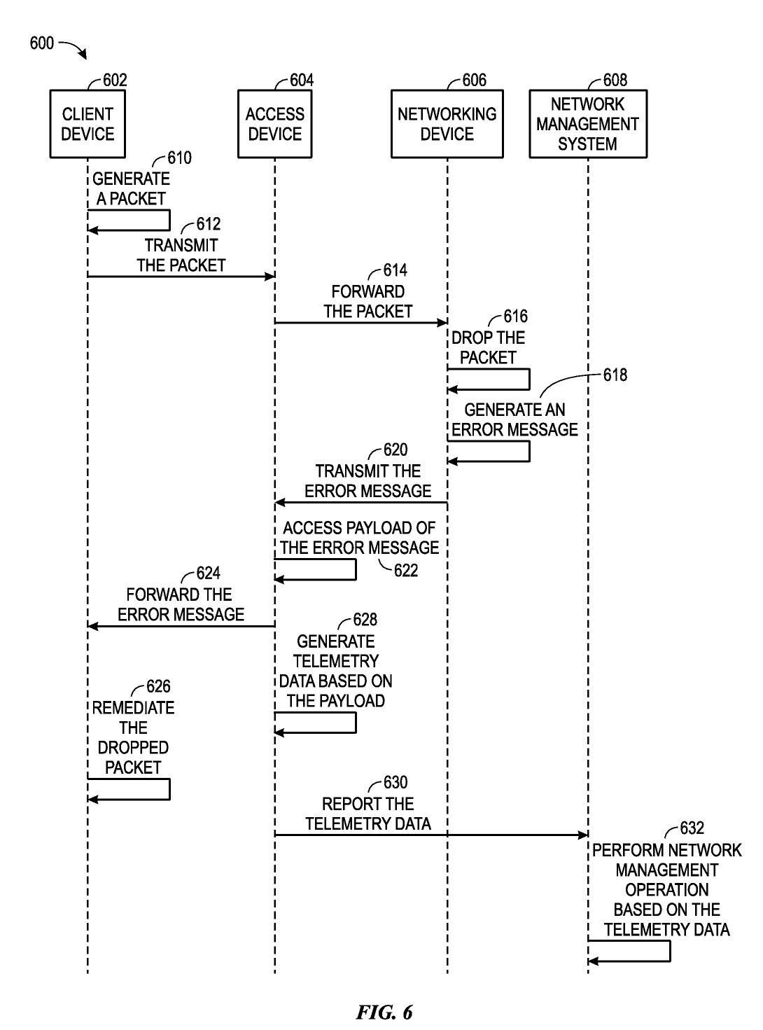

FIG. 6 is a sequence diagram of a process 600 that may be deployed by processing resources of a client device 602, an access device 604, one or more networking device(s) 606, and a network management system 608 to implement access device telemetry reporting after a network access drop occurs. The client device 602 may be implemented similar to the client device 110 of FIG. 1. The access device 604 may be implemented similar to the access device 108 of FIG. 1. The networking device(s) 606 may be between the access device 604 and a destination device along a path of travel for the packet. The networking device(s) 606 may be implemented similar to the networking device 102 or the networking device 104 of FIG. 1. The network management system 608 may be implemented similar an example of the network management system 128 of FIG. 1.

The client device 602 generates a packet (610). The packet may be implemented similar to a packet of the packets 124 of FIG. 1. The packet may be transmitted as part of packets transmitted as traffic through a network. The network may be implemented similar to the network 106 of FIG. 1. The client device 602 may generate the packet to communicate a request, audio data, image data, video stream data, application data, telecommunication data, or the like to a destination device. The destination device may be implemented similar to the destination device 112 of FIG. 1.

The client device 602 may transmit the packet via interface circuitry to the access device 604 (612). The interface circuitry may be implemented similar to the interface circuitry of FIG. 1. For example, the client device 602 may transmit the packet through a connection made between interface circuitries of the client device 602 and the access device 604.

The access device 604 receives, via the interface circuitry, the packet from the client device 602. The access device 604 may provide access to the network for the client device 602, which enables the client device 602 to communicate with the destination device through exchange of packets through the network.

The access device 604 forwards, via the interface circuitry, the packet (614). The access device 604 may forward the packet to the networking device 606. For example, the access device 604 may forward the packet through a connection made between interface circuitries of the access device 604 and the networking device 606. In some systems, the access device 604 may communicate based on an overlay network. When the access device 604 communicates with the network using an overlay network, the access device 604 may encapsulate the packet for forwarding as encapsulated traffic to the networking device 606. Encapsulation operations performed at block 612 may be implemented similar to encapsulation operations described relative to at least FIG. 4.

The networking device 606 receives, via interface circuitry, the packet from the access device 604. The networking device 606 may forward packets from the access device 604 onto a destination device indicated in a header of the packet. As part of this operation, the networking device 606 may determine whether to drop the packet, may report when the packet is dropped, may route the packet to another networking device, or the like.

For example, in response to receiving the packet, the networking device 606 drops the packet (616). Any suitable reason may be used, and definitions of the drop reasons described relative to at least FIG. 2 apply herein. For example, the networking device 606 may determine to drop the packet based on determining that a TTL was exceeded, corresponding to “TTL-0” drop reason, which may be mapped to an ICMP error of ICMP Type-11 (Time to live exceeded). In implementations with multiple networking device(s) 606 between the access device 604 and a destination device, each of the networking device(s) 606 may forward received packets along the path until one of the networking device(s) 606 drops the packet. In some cases, the networking device 606 may drop the packet without determining first to intentionally drop the packet, which may correspond to a networking device or network reliability type of drop reason.

The networking device 606 generates an error message (block 618). The error message may be implemented similar to the error message described relative to FIGS. 1-5, where the inset data table 324 may illustrate the data included in the error message. The error message may correspond to the packet that was dropped. The error message may include payload data with data related to the packet that was dropped. The error message may be associated with the packet being dropped by the networking device 606 while in transit to the destination device, where being in transit may involve the packet being transmitted among networking devices until reaching the destination device. In response to generating the error message, the networking device 606 may transmit, via the interface circuitry, the error message to the access device 604. In implementations with multiple networking device(s) 606 between the access device 604 and a destination device, each of the networking device(s) 606 may forward received error messages back along the path until the error message reaches the access device 604.

The networking device 606 transmits, via the interface circuitry, the error message (620). The access device 604 may receive, via the interface circuitry, the error message from the networking device 606. The access device 604 enables the client device 602 to receive the error message from the networking device 606 that dropped the packet. When the access device 604 communicates with the network using an overlay network, the access device 604 may receive an encapsulated error message. To forward the error message to the networking device 606, the access device 604 may decapsulate the encapsulated error message. Decapsulation operations performed at block 620 may be implemented similar to decapsulation operations described relative to at least FIG. 4.

The access device 604 accesses a payload of the error message (622). The access device 604 may snoop the error message to access the error message payload. The access device 604 may lift the error message to its processing resource to access the error message. The payload data of the error message may include at least some data of the packet that was dropped, along with other data associated with the packet, the dropping of the packet, the network device associated with the dropping of the packet, or the like.

The access device 604 forwards, via the interface circuitry, the error message (624). Forwarding the error message enables the client device 602 to be notified when one of its packets is dropped in transit to the destination device. If the network is an overlay network, the access device 604 may decapsulate the error message received as part of encapsulated traffic before forwarding the error message to the client device 602, such as at block 620. In some implementations, the VTEP of the overlay network may be at a location other than the access device 604. In such implementations, the VTEP (e.g., networking device 606) may decapsulate the error message received from another networking device (e.g., another networking device 606 along the path). This decapsulated error message forwarded by the access device 604 may be enriched with overlay network information (e.g., VLAN IDs, IP addresses) along with underlay information about the dropped packet.

The client device 602 receives, via the interface circuitry, the error message from the access device 604. The payload data of the error message may include at least some data of the packet that was dropped. The client device 602 may identify the packet that was dropped from the data included in the payload data.

The client device 602 remediates the dropped packet (626). The client device 602, having identified the packet that was dropped, may retransmit the packet or perform another remediation operation to cure or reduce a perceivability of the dropped packet.

Returning to operation 622, the access device 604 generates telemetry data based on the payload of the error message (628). The telemetry data may be implemented similar to the telemetry data 130 of FIG. 1 and/or the telemetry data described relative to FIGS. 2-5. The access device 604 may generate the telemetry data based on accessing payload data of the payload of the error message. The access device 604 may generate the telemetry data based on encoding the type of drop in the telemetry data, where the payload data of the error message may include a type of drop. The telemetry data may indicate the IP address of the networking device that generated the error message, here the networking device 606, and the drop reason. The access device 604 may generate the telemetry data to include data illustrated in the inset data table 326 of FIG. 3 and/or data illustrated in the inset data table 440 when the network is an overlay network.

The access device 604 reports, via the interface circuitry, the telemetry data (630). The access device 604 may report the telemetry data to the network management system 608 by pushing an updated cache to the network management system 608, by generating a packet with the updated data for reporting to the network management system 608, or another suitable reporting method. For example, the access device 604 may store the telemetry data in a cache and may export the cache to report the telemetry data to the network management system 608.

The network management system 608 receives, via the interface circuitry, the telemetry data from the access device 604. The network management system 608 may receive the telemetry data from the access device 604 by receiving an updated cache pushed from the access device 604, by receiving a packet generated with the updated data for reporting, or another suitable reporting method.

The network management system 608 performs a network management operation based on the telemetry data (632). For example, the network management system 608 may analyze network drops to diagnose network performance changes over time, to identify relatively less reliable networking devices compared to other networking devices, to identify possible spoofing or other types of attacks that may be coordinated between multiple networks (including the network), or the like. The network management system 608 may receive telemetry data relative to one or more networks, which may include the network accessed through the access device 604. The network management system 608 may store telemetry data over time to track and analyze changes in network performances. The network management system 608 may compare performance changes over time of the network to changes of one or more other networks and/or to its own changes over time, which the network management system 608 may use to perform root cause analysis, generate maintenance operation recommendations, generate networking device routing configurations or policies, or the like.

It is noted that the systems and methods described herein may relate to packet forwarding drops and network access drops in overlay networks and in networks without an overlay network. These systems and methods may be extended to apply to queue congestion related drops and/or other drops related to network congestion. Examples of drops related to network congestion include queue-full drops or weighted random early detection (WRED) threshold-exceeded drops. To extend these systems and methods to these types of drops, the networking device that is dropping a packet due to network congestion may copy the packet to its processing resources and generate an error message toward the client device that generated the packet. The error message may be an ICMP error message, such as an ICMP source-quench error. The access device may snoop the error message and identify the dropping networking device to identify the 5-tuple flow that was dropped. The dropping networking device may also indicate in the error message an egress port and a queue associated with the 5-tuple flow that was dropped. The access device may report this additional information (e.g., egress port and the queue) with the telemetry data.

It is noted that although described separately, operations described herein may be combined. For example, telemetry data reported may include data accessed from multiple error messages over time. As another example, operations of process 200 may be performed at a first time, such as in response to a forwarding drop occurring, and operations of process 500 may be performed at a second time in response to a network access drop occurring. For example, the access device may report, at a first time, first telemetry data and, at a second time, second telemetry data to the network management system, where the first telemetry data may include data extracted from a first error message generated from a first networking device, and where the second telemetry data may include data used in an error message generated by the access device. Similarly, telemetry data reporting by the access device for other networking devices implemented in an overlay network (operations described relative to FIG. 4 which may not involve snooping) may be combined with operations described relative to process 500 (which may involve the access device generating its own error message based on performing a traffic validation operation) and/or operations described relative to FIG. 3 (which may involve snooping). For example, the access device may report, at a first time, first telemetry data and, at a second time, second telemetry data to the network management system, the first telemetry data may include data extracted from a first error message generated by a first networking device in response to dropping a packet of an encapsulated traffic in an overlay network, and where the second telemetry data may include data used in an error message generated by the access device. As another example, the first telemetry data may include data extracted from a first error message generated by a first networking device in response to dropping a packet of an encapsulated traffic in an overlay network, and where the second telemetry data may include data extracted from a second error message generated by a second networking device from dropping a packet in an underlay network.

Technical effects of the present disclosure include centralizing telemetry data generation and reporting at one or more access devices of a network, which may reduce complexity of managing telemetry data operations and implementing such reporting in the network. For example, lower complexity installation and management may increase adoption in networks, which may contribute to improvements in network reliability. Systems and methods described herein enable telemetry data generation and reporting without any or with a reduced number of changes to a core configuration of networking devices through leveraging error message reporting operations that some networking devices may perform. Systems and methods described herein also enable integration of telemetry data generation and reporting in overlay networks, networks without a non-overlay network, and in networks where access devices may drop packets (e.g., network access drop) in similar or same processes.

One or more specific aspects of the present disclosure will be described below. In an effort to provide a concise description of these aspects, all features of an actual implementation may not be described in the specification. It should be appreciated that in the development of any such actual implementation, as in any engineering or design project, numerous implementation-specific decisions are made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various aspects of the present disclosure, the articles “a,” “an,” “the,” and “said” are intended to mean that there are one or more of the elements. The terms “comprising,” “including,” and “having” are intended to be inclusive and mean that there may be additional elements other than the listed elements.

While certain features of the present disclosure have been illustrated and described herein, many modifications and changes will occur to those skilled in the art. It is, therefore, to be understood that the appended claims are intended to cover all such modifications and changes as fall within the true spirit of the present disclosure.

1. An access device, comprising:
interface circuitry configured to establish one or more communication links with a networking device, a client device, and a network management system; and
at least one processing resource configured to:
receive, via the interface circuitry, a packet from the client device;
receive, via the interface circuitry, an error message from the networking device, wherein the error message is associated with the packet being dropped while in transit;
extract payload data from the error message, wherein the payload data comprises data related to the packet;
generate telemetry data based on the payload data; and
report, via the interface circuitry, the telemetry data to the network management system.

2. The access device of claim 1, wherein the at least one processing resource is configured to receive the error message from a virtual tunnel end point (VTEP).

3. The access device of claim 1, wherein the at least one processing resource is configured to receive the error message through snooping the error message.

4. The access device of claim 3, wherein the interface circuitry is configured to couple to the networking device, and wherein the error message is an Internet Control Message Protocol (ICMP) error message.

5. The access device of claim 1, wherein the error message comprises a type of drop, and wherein generating the telemetry data comprises encoding the type of drop in the telemetry data.

6. The access device of claim 5, wherein the type of drop comprises a packet forwarding drop in a network comprising an underlay network, wherein the at least one processing resource is configured to transmit, via the interface circuitry, the packet over an overlay network to the networking device as part of encapsulated traffic, and wherein the at least one processing resource is configured to receive the error message as part of decapsulating encapsulated traffic from the networking device.

7. The access device of claim 5, wherein the type of drop comprises a network access drop, and wherein the at least one processing resource is configured to:
receive, via the interface circuitry, an additional packet from the client device;
perform a traffic validation operation on the additional packet;
generate an additional error message based on performing the traffic validation operation, wherein additional payload data comprises additional data related to the additional packet;
generate additional telemetry data based on the additional payload data; and
report, via the interface circuitry, the additional telemetry data to the network management system.

8. The access device of claim 5, wherein the type of drop comprises a packet forwarding drop in a portion of an underlay network, and wherein the at least one processing resource is configured to receive the error message through snooping the error message.

9. The access device of claim 1, wherein the at least one processing resource is configured to transmit, via the interface circuitry, the error message to the client device.

10. A method, comprising:
receiving, via interface circuitry, a packet from a client device;
receiving, via the interface circuitry, an error message from a networking device, wherein the error message is associated with the packet being dropped while in transit;
extracting payload data from the error message, wherein the payload data comprises data related to the packet;
generating telemetry data based on the payload data; and
reporting, via the interface circuitry, the telemetry data to a network management system.

11. The method of claim 10, wherein generating the telemetry data comprises encoding a type of drop in the telemetry data, and wherein the error message comprises the type of drop.

12. The method of claim 11, comprising:
transmitting, via the interface circuitry, the packet over an overlay network to the networking device as part of encapsulated traffic; and
receiving, via the interface circuitry, the error message as part of decapsulating encapsulated traffic from the networking device, wherein the type of drop comprises a packet forwarding drop in a network comprising an underlay network.

13. The method of claim 10, comprising:
receiving, via the interface circuitry, an additional packet from the client device;
performing a traffic validation operation on the additional packet;
generating an additional error message based on performing the traffic validation operation, wherein additional payload data comprises additional data related to the additional packet, wherein the additional error message comprises an additional type of drop of a network access drop;
generating additional telemetry data based on the additional payload data; and
reporting, via the interface circuitry, the additional telemetry data to the network management system.

14. The method of claim 10, comprising transmitting, via the interface circuitry, the error message to the client device.

15. A tangible, non-transitory, computer-readable medium, comprising computer-readable instructions that, when executed by one or more processing resources of an access device, cause the access device to:
receive, via interface circuitry, a packet from a client device;
receive, via the interface circuitry, an error message from a networking device, wherein the error message is associated with the packet being dropped while in transit;
extract payload data from the error message, wherein the payload data comprises data related to the packet;
generate telemetry data based on the payload data; and
report, via the interface circuitry, the telemetry data to a network management system.

16. The tangible, non-transitory, computer-readable medium of claim 15, wherein generating the telemetry data comprises encoding a type of drop in the telemetry data, and wherein the error message comprises the type of drop.

17. The tangible, non-transitory, computer-readable medium of claim 16, comprising computer-readable instructions that, when executed by the one or more processing resources of the access device, cause the access device to:
transmit, via the interface circuitry, the packet over an overlay network to the networking device as part of encapsulated traffic; and
receive, via the interface circuitry, the error message as part of decapsulating encapsulated traffic from the networking device, wherein the type of drop comprises a packet forwarding drop in a network comprising an underlay network.

18. The tangible, non-transitory, computer-readable medium of claim 15, comprising computer-readable instructions that, when executed by the one or more processing resources of the access device, cause the access device to:
receive, via the interface circuitry, an additional packet from the client device;
perform a traffic validation operation on the additional packet;
generate an additional error message based on performing the traffic validation operation, wherein additional payload data comprises additional data related to the additional packet, wherein the additional error message comprises an additional type of drop of a network access drop;
generate additional telemetry data based on the additional payload data; and
report, via the interface circuitry, the additional telemetry data to the network management system.

19. The tangible, non-transitory, computer-readable medium of claim 15, comprising computer-readable instructions that, when executed by the one or more processing resources of the access device, cause the access device to transmit, via the interface circuitry, the error message to the client device.

20. The tangible, non-transitory, computer-readable medium of claim 15, wherein receiving the error message comprises snooping the error message.
